(19) United States
(12) Patent Application Publication
(10) Pub. No.: US 2014/0344721 A1
(43) Pub. Date: Nov. 20, 2014

(54) APPARATUS AND METHOD FOR COLLATING APPLICATION EVENTS WITH CONTACTS OF AN ELECTRONIC DEVICE

(71) Applicant: Priya Prakash, London (GB)

(72) Inventor: Priya Prakash, London (GB)

(73) Assignee: Nokia Corporation, Espoo (FI)

(21) Appl. No.: 14/365,203

(22) PCT Filed: Dec. 21, 2011
(86) PCT No.: PCT/IB2011/055869

§ 371 Date: Jun. 13, 2014

(51) Int. Cl. G06F 3/0482; H04L 29/12

(52) U.S. Cl. CPC G06F 3/0482; H04L 61/6077
USPC 715/753

(57) ABSTRACT

An apparatus comprising at least one processor; and at least one memory including computer program code, the at least one memory and the computer program code configured to, with the at least one processor, cause the apparatus to perform at least the following: identify user application events associated with one or more contacts of an electronic device; and collate the user application events associated with one or more particular contacts, with the corresponding particular contact.

### TECHNICAL FIELD

The present disclosure relates to the field of communication devices, associated methods, computer programs and apparatus. Certain disclosed aspects/embodiments relate to portable electronic devices, in particular, so-called hand-portable electronic devices which may be hand-held in use (although they may be placed in a cradle in use). Such hand-portable electronic devices include so-called Personal Digital Assistants (PDAs) and tablet PCs.

The portable electronic devices/apparatus according to one or more disclosed aspects/embodiments may provide one or more audio/text/video communication functions (e.g. tele-communication, video-communication, and/or text transmission (Short Message Service (SMS)/Multimedia Message Service (MMS)/emailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

Electronic devices may be configured to allow communication with other electronic devices. Communication may be from one person to another person via making/receiving telephone calls, via the transmission/receipt of text messages such as short message service (SMS), multimedia messaging service (MMS), e-mail or fax messages, or via the transmission/receipt of video or audio messages. Communication may also be from one person to a group of one or more other people, such as by the transmission/receipt of data relating to internet/intranet/network-based websites. Such data may comprise social media updates, ‘blog/micro’blog posts, or news feeds. Communications may be transmitted and received using applications available on the electronic device.

A person using an electronic device configured for communication may receive communications from several other contacts relating to a plurality of communication types and/or applications. The person receiving the communications may wish to receive a notification of when a new communication has been received.

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

In a first aspect there is provided an apparatus comprising at least one processor; and at least one memory including computer program code, the at least one memory and the computer program code configured to, with the at least one processor, cause the apparatus to perform at least the following: identify user application events associated with one or more contacts of an electronic device; and collate the user application events associated with one or more particular contacts, with the corresponding particular contact. Thus user application events may be conveniently grouped by contact so that a user can readily see a particular contact's user application event activity.

A user application event may be an event such as an e-mail or text message being received, a call being made/missed, a social media update, news feed update, or a chat-based message. The user application event may be received by the apparatus and may be related to a user application. A particular contact may be a contact selected as a contact of particular interest, such as a favourite contact (e.g. a best friend or partner).

The user application events may be associated with a plurality of user applications available on the electronic device. That is, the user application events collated and associated with a particular contact may be related to a variety of different user applications, such as missed telephone calls (e.g. mobile telephone, landline telephone or internet-based), received SMS/MMS messages, received e-mails, social media status updates, micro′blog updates, chat-based messages and news feed alerts.

The user application events may be associated with one user application available on the electronic device. That is, the user application events collated and associated with a particular contact may be related to only one user application. For example, SMS messages, MMS message and video messages may all be received by the same user (messaging) application, but are different user application events. As another example, Facebook status updates, Facebook event invitations and Facebook direct messages are all different user application events which are associated with one user application (Facebook).

The one or more contacts may be addressable using at least one of the plurality of user applications. For example, a contact may send an e-mail which is received by the apparatus. A user may be able to address the contact by replying to the sent e-mail using the apparatus or be able to send an email to the contact given that their address details are available to the apparatus, for example, being stored in a contacts list. It will be apparent that the address is used to provide outgoing communications from the apparatus. As another example, a contact may call the apparatus, and a user may be able to address the contact by accepting the call, or by making a return call to the contact using the apparatus. Similarly, the address of the contact is useable to send an outgoing communication.

The one or more contacts addressable using at least one of the plurality of user applications may each have an associated unique identifier. For example, a (particular) contact may have one or more of an e-mail account, a mobile telephone number, a home telephone number, a fax number, a Facebook (and/or other social media) account and a Twitter (or other ‘blog/micro’blog) account. The contact may have a different username or online ID for their different accounts, for example, their name, telephone and fax number(s) and e-mail address(es) may be stored in the contact list (of the apparatus) under one name, they may have a different username on their Facebook account, and a further different username on their Twitter account. The user of the apparatus may wish to receive notifications of user application events collated for a particular contact regardless of the contact name/username/online ID used. The user therefore is able to associate a unique identifier to that contact. Thus the user may be able to associate the same unique identifier to the contact list entry, the Facebook account and the Twitter account of the same particular contact person, so that the apparatus is able to collate user application events for that one contact person together, irrespective of the different user names or online IDs used by that contact.

For instance, a user may be called Jason Brown (and his telephone/fax numbers and e-mail address(es) may be stored in the contact list of the apparatus under the name Jason Brown). He may also have a Facebook account in the user name “Jason ‘Biggie’ Brown”, for example, and a Twitter account under the online ID “JB1982”. The same unique identifier may be associated with that contact (in effect, to the different user names/online IDs associated with that contact) so that all the user application events reporting events from Jason Brown, including calling/messaging/e-mailing, Facebook activity (as “Jason ‘Biggie’ Brown”) and Twitter activity (as “JB1982”) are collated under a single contact name (e.g. Jason Brown).

The one or more contacts may not be addressable using at least one of the plurality of user applications. A contact may be considered as another party from whom user application events are received. Such a non-addressable contact may be a website to which the user of the apparatus has subscribed to receive news stories, RSS news feeds, or notifications that updates have been made to a particular site. In these cases the contact (the website) can be considered to be non-addressable, and communications are incoming only (rather than outgoing only, or incoming and outgoing).

The user may be also to select which, of the plurality of user application events, are collated for a particular contact. For example, if a particular contact posts several status updates on Facebook, or several micro′blog entries on Twitter, which the user is not interested in reading, the user may be able to choose not to collate Facebook and/or Twitter user application events for that particular contact. The user can still collate other user application events from other user applications for that contact, such as missed calls, SMS/MMS messages, e-mails, or other user application events of interest to the user. The user may be able to choose to exclude e.g. Twitter based user application events from collated user application events for all contacts, perhaps by applying that option across all contacts.

The collated user application events associated with the one or more particular contacts may be prioritised over user application events from one or more other contacts. Thus, collation may be prioritised for certain contacts over other contacts including providing collation for certain particular contacts, but not for other contacts.

The apparatus may be configured to display at least one notification of the collated user application events. The at least one notification of the collated user application events may be available alongside one or more of a plurality of user applications. That is, a user of the apparatus may have access to read and/or act upon such notifications of collated user application events (e.g. in a banner or pop-up) while also having the ability to use one or more user applications. For example, the collation may appear on a homescreen on which icons providing access to other applications are also presented. As another example, the user may be using an application in one window of a display and have the collated notifications appearing in another (e.g. adjacent) window at the same time, so that both can be seen at the same time. The applications to which the collated user application events relate may not necessarily be the only user applications which the user is able to access.

Notifications informing a user of the apparatus of user application events, collated according to one or more particular contacts, may appear in a prioritised location on the device, such as at the top of a list relating to event notifications. Such collated user application events, and/or one or more particular contacts may also be prioritised by, for example, sounding an alert when a user application event notification is received from a particular contact, whereas user application events relating to other (non-particular) contacts may not cause an alert to be sounded when received. Such collated user application events, and/or one or more particular contacts may also be prioritised by, for example, notification of such collated user application events from particular contacts appearing in a highlighted way on the apparatus, perhaps on a particular colour background, or larger than user application events not received by particular contacts.

The apparatus may be configured to display at least a portion of the collated user application events. Thus, the apparatus can provide some details regarding the latest event(s), for example, so that the user can see whether the full content of the latest event needs to be viewed (for example, in the case of receiving an e-mail, not all the e-mail content may be viewed in the notification screen and the user may need to read the e-mail in a e-mail application to see all the content). The at least a portion of the collated user application events may be available alongside a plurality of user applications. A user may be able to view, for example, at least a part of an e-mail or message received as a user application event which he or she is being notified of.

The collated user application events may be displayed using a combination of one or more of: a text-based list, a list of icons, a drop-down menu, a notification bar, a pop-up notification, a banner, a notification menu, a blow-out, and an events screen.

The user application may be one of a calling application, a text-based messaging application, an e-mail application, a social media application, a news feed application, or a chat application.

The apparatus may be configured to display at least one indication of the one or more particular contacts. Such an indication may be a special mark or highlighting applied to the details of such a particular contact when viewed in an e.g. contact list. For example, a particular contact may appear in a list of all contacts with a special icon such as a star or heart next to their name to show they are selected as a particular contact, and from whom user application events will be displayed to the user in a collated fashion. The particular contact may appear in bold, or a larger font, or in a different colour, compared to other (non-particular) contacts. An icon may be available displayed on the device for each particular contact, which may be selectable by a user to allow for further functionality associated with that particular contact. Such icons of differentiation may not be available for non-particular (other) contacts.

The apparatus may be a portable electronic device, a laptop computer, a mobile phone, a Smartphone, a tablet computer, a personal digital assistant, a digital camera, a watch, a server, or a module/circuitry for one or more of the same. The apparatus may be a non-portable electronic device, a desktop computer, a monitor, a server, or a module/circuitry for one or more of the same.

In a further aspect there is provided a method, the method comprising identifying user application events associated with one or more contacts of an electronic device, and collating the user application events associated with one or more particular contacts, with the corresponding particular contact.

In a further aspect there is provided a computer readable medium comprising computer program code stored thereon, the computer readable medium and computer program code being configured to, when run on at least one processor, perform at least the following: identify user application events associated with one or more contacts of an electronic device, and collate the user application events associated with one or more particular contacts, with the corresponding particular contact.

In a further aspect there is provided an apparatus, the apparatus comprising means for identifying user application events associated with one or more contacts of an electronic device, and means for collating the user application events associated with one or more particular contacts, with the corresponding particular contact.

The present disclosure includes one or more corresponding aspects, embodiments or features in isolation or in various combinations whether or not specifically stated (including claimed) in that combination or in isolation. Corresponding means for performing one or more of the discussed functions are also within the present disclosure.

Corresponding computer programs for implementing one or more of the methods disclosed are also within the present disclosure and encompassed by one or more of the described embodiments.

The above summary is intended to be merely exemplary and non-limiting.

### BRIEF DESCRIPTION OF THE FIGURES

A description is now given, by way of example only, with reference to the accompanying drawings, in which:

FIG. 1 illustrates an example apparatus according to the present disclosure;

FIG. 2 illustrates another example apparatus;

FIG. 3 illustrates a further example apparatus;

FIGS. 4a-4c illustrate an example embodiment of an apparatus displaying particular contact details and particular user application events associated with a particular contact;

FIGS. 5a-5e illustrate an example embodiment of an apparatus displaying user application events associated with one or more contacts;

FIGS. 6a-6c illustrate an further example embodiment of an apparatus displaying user application events associated with one or more contacts;

FIG. 7 illustrates a flowchart according to a method of the present disclosure; and

FIG. 8 illustrates schematically a computer readable medium providing a program.

### DESCRIPTION OF EXAMPLE ASPECTS/EMBODIMENTS

Electronic devices may be configured to allow communication with other electronic devices. Communication may be made via telephone calls, textual messages such as SMS, MMS, e-mail or fax messages, video or audio messages, social media updates, ‘blog/micro’blog posts, or news feeds. Communications may be transmitted and received using applications available on the electronic device, and receipt of such communications may be considered as user application events.

A person using an electronic device/apparatus configured for communication may receive communications from several other contacts relating to a plurality of communication types and/or applications. That is to say, a user may use a device which is configured to make/receive calls, send/receive textual, image-based and video messages, and post/receive social media updates, ‘blog entries, and news feeds such as RSS feeds. These different respective events may use different applications and/or multiple different respective events may use the same application. In the case where multiple applications are used, it will be appreciated that the respective events are accessed by accessing the respective application.

The user may wish to receive a notification of when a new communication has been received by the device. In this way, if the user begins to use the device after a period of time of not using the device, any communication which has occurred during that period of time may be indicated on the device so that the user is aware of any communications sent to him or her. Such notifications may be that a telephone call has been missed, that some of the user's social media contacts have posted new entries, or that new news feeds have become available to read.

It may be imagined that such a user may receive several notifications related to different contacts, possibly relating to different applications. The user may find it advantageous that notifications/events, possibly from different applications, are collated/grouped together by their contacts rather than being distributed through multiple application or multiple separate notification systems/applications.

The user may also find it advantageous to be able to prioritise some notifications over others. For example, the user may wish to receive notifications from their close friends and family as a priority over notifications received from other contacts, for example, from social media contacts. Alternatively, a user may wish to receive notifications from business colleagues as a priority over other non-business contacts.

Such a user may also find it advantageous to not only prioritise the notifications received from particular contacts, but to be able to see such notifications regardless of the application currently in use on the device. For example, a user may be using a social media application such as Facebook, Twitter, or LinkedIn, and wish to receive notifications of user application events not only from the social media application in use, but also from other applications, such as notifications of missed calls, text messages and e-mails. Further, a user may wish to switch between using different applications and still be able to see notifications relating to other different applications.

Such a user may further find it advantageous if they are able to select a particular notification and take further action related to that notification. If, for example, a user is browsing a website, and they receive a notification that a contact has sent them an e-mail, it may be useful for the user to be able to select the notification in some way and access the received e-mail—whether by reading the e-mail in a sub-application while the website they were browsing is still present in the background, or by switching application to an e-mail application.

One or more embodiments described herein may be considered to provide an apparatus which can identify user application events associated with one or more contacts of an electronic device, and collate the user application events associated with one or more particular contacts, with the corresponding particular contact.

For example, the apparatus may identify communications and updates (user application events) received from several contacts, those user application events being associated with one or more particular user applications. The contacts may be addressable using the apparatus, i.e. they may be called, or sent a message or e-mail, or a social media status may be updated/responded to using the apparatus. The user application events may be collated to provide a list of notifications of events received from a particular contact. These events may or may not relate to several applications. This collation may relate to one or more particular contacts; such particular contacts may be favourite contacts that the user has identified, such as partners, best friends or close family members. The notifications from various applications may be grouped by such contacts.

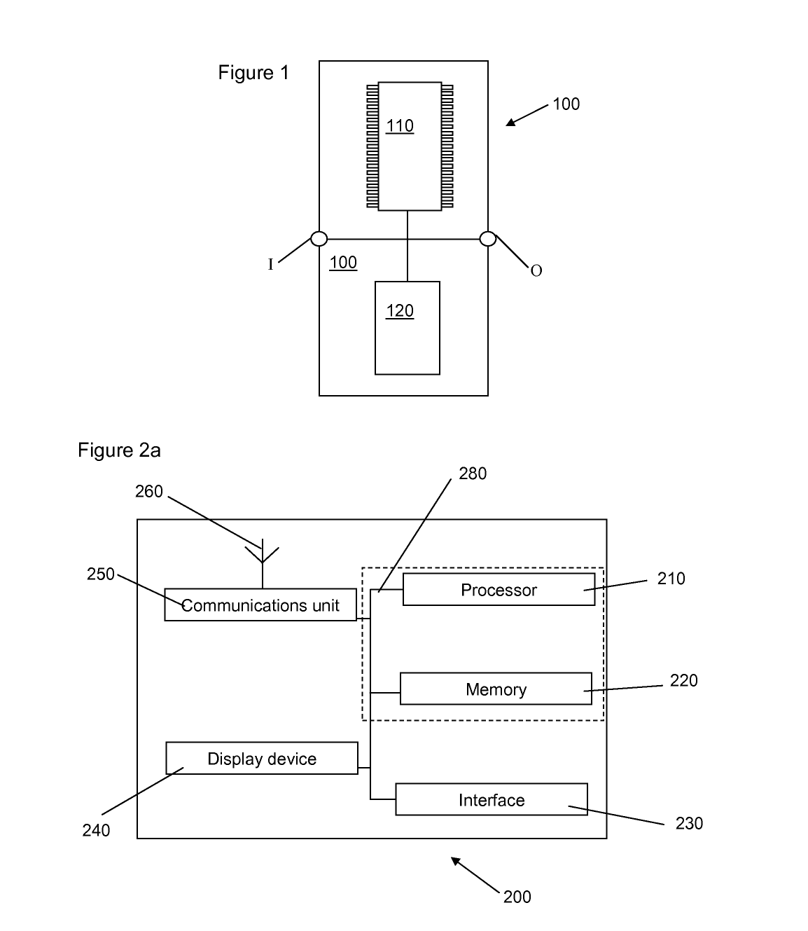

FIG. 1 shows an apparatus 100 comprising a processor 110, memory 120, input I and output O. In this embodiment only one processor and one memory are shown but it will be appreciated that other embodiments may utilise more than one processor and/or more than one memory (e.g. same or different processor/memory types). The apparatus 100 may be an application specific integrated circuit (ASIC) for a portable electronic device. The apparatus 100 may also be a module for a device, or may be the device itself, wherein the processor 110 is a general purpose CPU and the memory 120 is general purpose memory.

The input I allows for receipt of signalling to the apparatus 100 from further components. The output O allows for onward provision of signalling from the apparatus 100 to further components. In this embodiment the input I and output O are part of a connection bus that allows for connection of the apparatus 100 to further components. The processor 110 is a general purpose processor dedicated to executing/processing information received via the input I in accordance with instructions stored in the form of computer program code on the memory 120. The output signalling generated by such operations from the processor 110 is provided onwards to further components via the output O.

The memory 120 (not necessarily a single memory unit) is a computer readable medium (such as solid state memory, a hard drive, ROM, RAM, Flash or other memory) that stores computer program code. This computer program code stores instructions that are executable by the processor 110, when the program code is run on the processor 110. The internal connections between the memory 120 and the processor 110 can be understood to provide active coupling between the processor 110 and the memory 120 to allow the processor 110 to access the computer program code stored on the memory 120.

In this embodiment the input I, output O, processor 110 and memory 120 are electrically connected internally to allow for communication between the respective components I, O, 110, 120, which in this example are located proximate to one another as an ASIC. In this way the components I, O, 110, 120 may be integrated in a single chip/circuit for installation in an electronic device. In other embodiments one or more or all of the components may be located separately (for example, throughout a portable electronic device such as devices 200, 300, or through a “cloud”, and/or may provide/support other functionality.

One or more examples of the apparatus 100 can be used as a component for another apparatus as in FIG. 2, which shows a variation of apparatus 100 incorporating the functionality of apparatus 100 over separate components. In other examples the device 200 may comprise apparatus 100 as a module (shown by the optional dashed line box) for a mobile phone or PDA or audio/video player or the like. Such a module, apparatus or device may just comprise a suitably configured memory and processor.

The example apparatus/device 200 comprises a display 240 such as, a Liquid Crystal Display (LCD), e-Ink, or touch-screen user interface. The device 200 is configured such that it may receive, include, and/or otherwise access data. For example, device 200 comprises a communications unit 250 (such as a receiver, transmitter, and/or transceiver), in communication with an antenna 260 for connection to a wireless network and/or a port (not shown). Device 200 comprises a memory 220 for storing data, which may be received via antenna 260 or user interface 230. The processor 210 may receive data from the user interface 230, from the memory 220, or from the communication unit 250. Data may be output to a user of device 200 via the display device 240, and/or any other output devices provided with apparatus. The processor 210 may also store the data for later user in the memory 220. The device contains components connected via communications bus 280.

The communications unit 250 can be, for example, a receiver, transmitter, and/or transceiver, that is in communication with an antenna 260 for connecting to a wireless network and/or a port (not shown) for accepting a physical connection to a network, such that data may be received via one or more types of network. The communications (or data) bus 280 may provide active coupling between the processor 210 and the memory (or storage medium) 220 to allow the processor 210 to access the computer program code stored on the memory 220.

The memory 220 comprises computer program code in the same way as the memory 120 of apparatus 100, but may also comprise other data. The processor 210 may receive data from the user interface 230, from the memory 220, or from the communication unit 250. Regardless of the origin of the data, these data may be outputted to a user of device 200 via the display device 240, and/or any other output devices provided with apparatus. The processor 210 may also store the data for later user in the memory 220.

Device/apparatus 300 may be an electronic device (including a tablet personal computer), a portable electronic device, a portable telecommunications device, or a module for such a device. The apparatus 100 can be provided as a module for device 300, or even as a processor/memory for the device 300 or a processor/memory for a module for such a device 300. The device 300 comprises a processor 385 and a storage medium 390, which are electrically connected by a data bus 380. This data bus 380 can provide an active coupling between the processor 385 and the storage medium 390 to allow the processor 380 to access the computer program code.

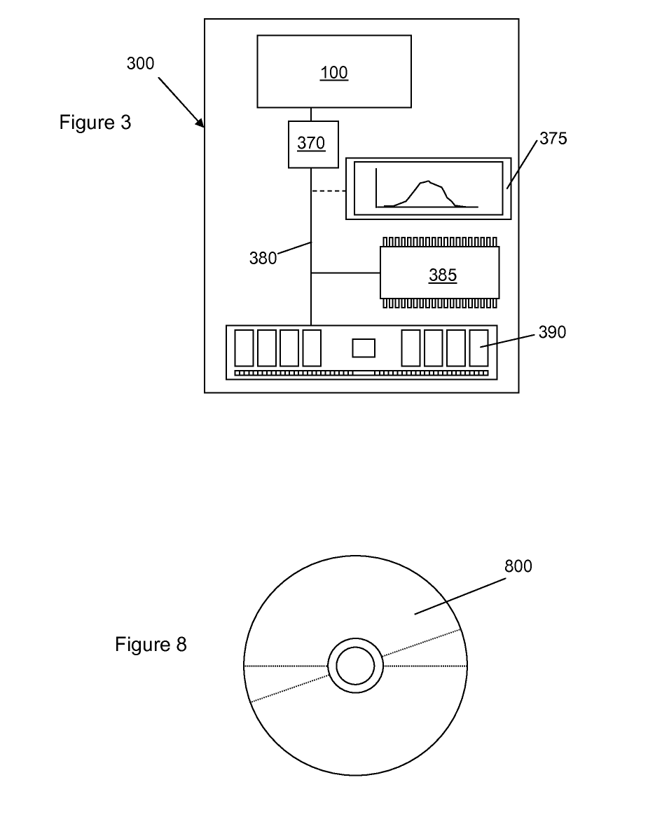

The apparatus 100 in FIG. 3 is electrically connected to an input/output interface 370 that receives the output from the apparatus 100 and transmits this to the device 300 via data bus 380. Interface 370 can be connected via the data bus 380 to a display 375 (touch-sensitive or otherwise) that provides information from the apparatus 100 to a user. Display 375 can be part of the device 300 or can be separate. The device 300 also comprises a processor 385 that is configured for general control of the apparatus 100 as well as the device 300 by providing signalling to, and receiving signalling from, other device components to manage their operation.

The storage medium 390 is configured to store computer code configured to perform, control or enable the operation of the apparatus 100. The storage medium 390 may be configured to store settings for the other device components. The processor 385 may access the storage medium 390 to retrieve the component settings in order to manage the operation of the other device components. The storage medium 390 may be a temporary storage medium such as a volatile random access memory. The storage medium 390 may also be a permanent storage medium such as a hard disk drive, a flash memory, or a non-volatile random access memory. The storage medium 390 could be composed of different combinations of the same or different memory types.

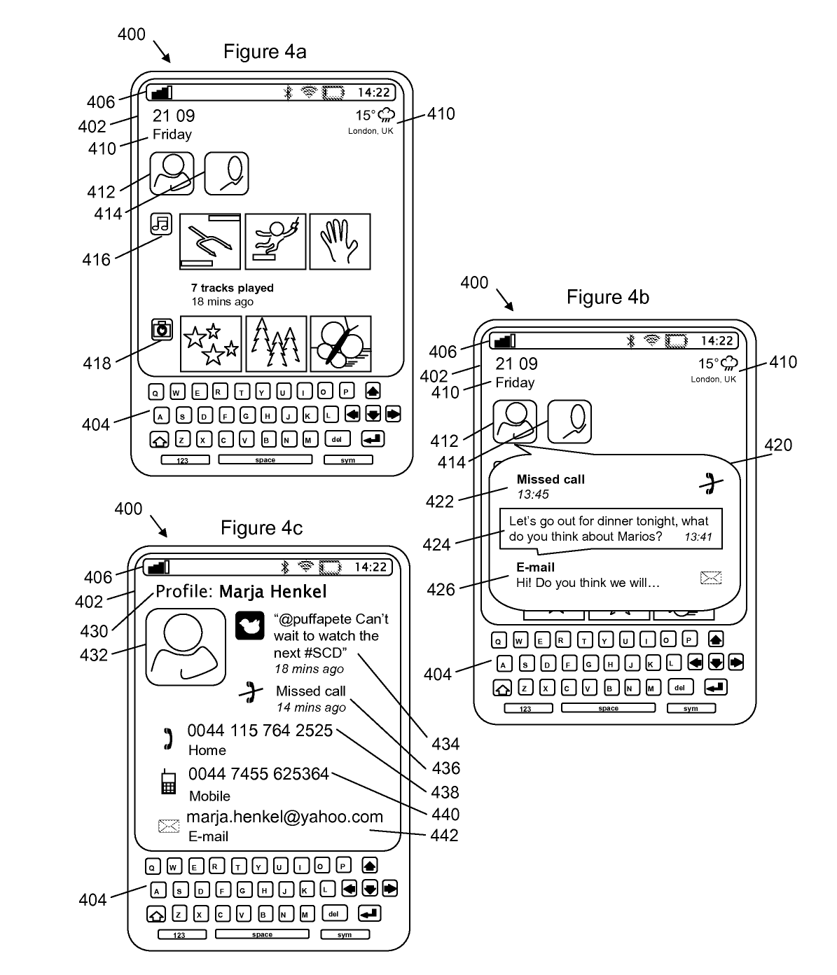

FIGS. 4a-4d illustrate an example embodiment of the apparatus which is a portable electronic device 400, such as a smartphone or PDA, in use. The device 400 in this example is capable of running a plurality of user applications and storing the details of a plurality of contacts.

FIG. 4a shows the device 400 with a touch sensitive screen 402 and a physical keyboard 404. An information bar 406 is displayed showing information such as the network signal strength, Bluetooth activity, other network activity, battery power remaining, and the current time. Other background information may be displayed on the screen such as the day and date 410, or the location and current weather conditions 410.

The device 400 has a plurality of user applications available on the device. Such applications displayed on the screen include a music player 416, and a camera application 418. Other applications may be available but are not displayed in FIG. 4a. Also displayed in FIG. 4a are two icons 412, 414, which indicate two particular contacts. These contacts may have been chosen by the user as “favourite” contacts; they may be people who are most frequently contacted or of most interest to the user. The icons 412, 414 which are displaying indications of these particular contacts may be considered to prioritise these contacts over other contacts, who do not have such an icon displayed. Favourite (particular) contacts may also be prioritised by, for example, displaying their entries differently in an address book or contact list than other non-favourite contacts. Particular contacts may be displayed in bold, in a different colour, on a differently coloured background, or with a symbol such as a star or heart next to the particular contact name to identify to the user that contact is marked as a particular (favourite) contact. Particular (favourite) contacts may also appear at the start of any contact list regardless of the general ordering (e.g. alphabetical) of names in the list.

FIG. 4b shows that the user has selected the icon 412 of one of the particular contacts. This selection has allowed the user to view collated user application events 420 associated with this particular contact. Thus at least one notification (the blow-out area 420) is displayed as a notification of the collated user application events. The area 420 could, for example, be a drop-down list or a pop-up notification area. It may contain text and/or icons. In this case, this notification is available alongside other user applications; the music application 416 and photo application 418 are still available in the background. It may be envisaged that if a particular contact having an icon such as icon 412, 414 has user application events associated with them which the user may wish to view, that the icon 412, 414 is highlighted in some way to indicate to the user that there are, for example, any number of user application events available to view. For example, the icon 412, 414 may appear with a (coloured) border (e.g. to provide a differentiation to show that events are associated with this contact), and/or include the number of events available to view, and/or include an indication, such as a logo or symbol, of the application with which each user application event is associated.

The apparatus has identified the user application events 422, 424, 426 made by this particular contact in different user applications available on the device, and has collated them for display as shown in FIG. 4b. For example, the particular contact 412 made a telephone call to the user at 13:45 which the user failed to answer, so this event 422 is displayed as a missed call. Although not shown, an SMS indicating a voice mail, associated with the missed call from the contact, may also be shown. The particular contact sent an SMS message to the user at 13:41 asking about going out for dinner, and this event 424 is displayed as an SMS message. The particular contact also sent an e-mail to the user and this event 426 is displayed as a title “E-mail” and by a portion of the e-mail being displayed. The displayed SMS message 424 and initial portion of the e-mail 426 may be considered to be at least a portion of the collated user application events; these portions of the collated user application events are available alongside a plurality of user applications, as is the notification.

It will be appreciated that the user application events in which a notification area 420 may relate to the same application. The user may have received an SMS message, an MMS message and/or a video message from this particular contact, and each message would appear in the area 420 as a user application event. As another example, the user may receive user application events of received e-mails (associated with one user application) from that particular contact.

The user may be able to select the missed call event notification 422 and return the call. The user may also be able to select the SMS message notification 424 to read the SMS message conversation (if any) and reply to the message, or select the e-mail notification 426 to be able to read the e-mail in full, and reply if desired. The contact is therefore addressable using at least one of the plurality of user applications, in that in this example they may be sent an SMS message, e-mail, or be called, through the collated view of events e.g. by tapping on the display over 424 (in area 420) to write a reply message.

It may be envisaged that the collated user application events area 420 may appear temporarily and may disappear after a preset period of time. Alternatively, the user may be required to make a further user input to hide this area 420 and revert to a screen such as that shown in FIG. 4a. The user may cause the area 420 to be hidden by selecting a user application event within the notification area 420.

FIG. 4c shows that the user has selected the icon 412 of one of the particular contacts in a different way. For example, the input made to see the screen of FIG. 4b may be a tap on icon 412, and the input made to see the screen of FIG. 4c may be a press or hold on icon 412. The input made to show the screen as in FIG. 4c has allowed the user to view collated user application events 434, 436 associated with this particular contact in an events screen/display. The user can also see other details of this particular contact, including her name 430, a photograph 432, her home telephone number 438, mobile telephone number 440 and e-mail address. The user may be able to scroll down this screen and see further details of the contact. At least one notification (in this case, two 434, 436) is displayed as a notification of the collated user application events. It may be that these notifications are available alongside other user applications; the music application 416 and photo application 418 may still be available in the background, and accessible, for example, by using a home key (not shown). It may be that user application events may be displayed which are associated with one user application. For example, missed telephone calls may be shown as user application events. As another example, Facebook status updates and Facebook invitations may be shown in the user application events screen. A further example is that SMS, MMS and video messages are associated with one (messaging) application and may be available on the electronic device/apparatus.

The apparatus has identified the user application events 434, 436 made by this particular contact in different user applications available on the device, and has collated them for display as shown in FIG. 4c. For example, the particular contact updated her micro′blog feed 18 minutes ago (434), and called the user, who missed the call, 14 minutes ago (436). Of course, rather than displaying how long ago an event happened, an actual time indication of the event can be provided (as in FIG. 4b). The displayed micro′blog entry 434 and missed call notification 436 may be considered to be at least a portion of the collated user application events; these portions of the collated user application events are available alongside a plurality of user applications in that the user may terminate viewing the contact details and user application event notifications as displayed and return to the screen of FIG. 4a where they are able to access other applications.

The user may be able to select the micro′blog entry 434 to read the contact's full micro′blog feed, or reply to the entry. The user may also be able to select the missed call event notification 436 and return the call. The contact is therefore addressable using at least one of the plurality of user applications, in that in this example they may be called, or their micro′blog may be commented on/responded to.

In the examples shown in FIGS. 4b and 4c, the particular contact indicated by icon 412 has communicated user application events related to a plurality of user applications available on the electronic device. It may be that the user has their contact details 430, 438, 440, 442, stored in a contacts list of the device under the name “Marja Henkel”. The same particular contact may have the Facebook identity “Marja Weissel” (for example, if they are using a different name for work and personal purposes), and the same particular contact may have the Twitter identity “MH_in_Berlin”. The particular contact may have an associated unique identifier, so that all the user application events relating to the contact's details stored in the contact lists (related to the user application events 422, 424, 426, 436) are displayed collated with the contact's Facebook-based user application events (not shown) and with the contact's Twitter user application events (such as Twitter post 434). In this way the user application events from a plurality of user applications, in which the same contact may have different user names, are collated for the same particular contact.

The examples shown in FIGS. 4a-4c may be considered to allow a user efficient access to information for contacts of particular interest, as the details for such particular (favourite) contacts and their associated user application activity over a possible range of applications is available in collated form, in this case on a homescreen of the device/apparatus. Updates (user application events) from particular contacts may be considered to be dynamically updated and easily/readily available for the user to see and be aware of his favourite contacts' activity.

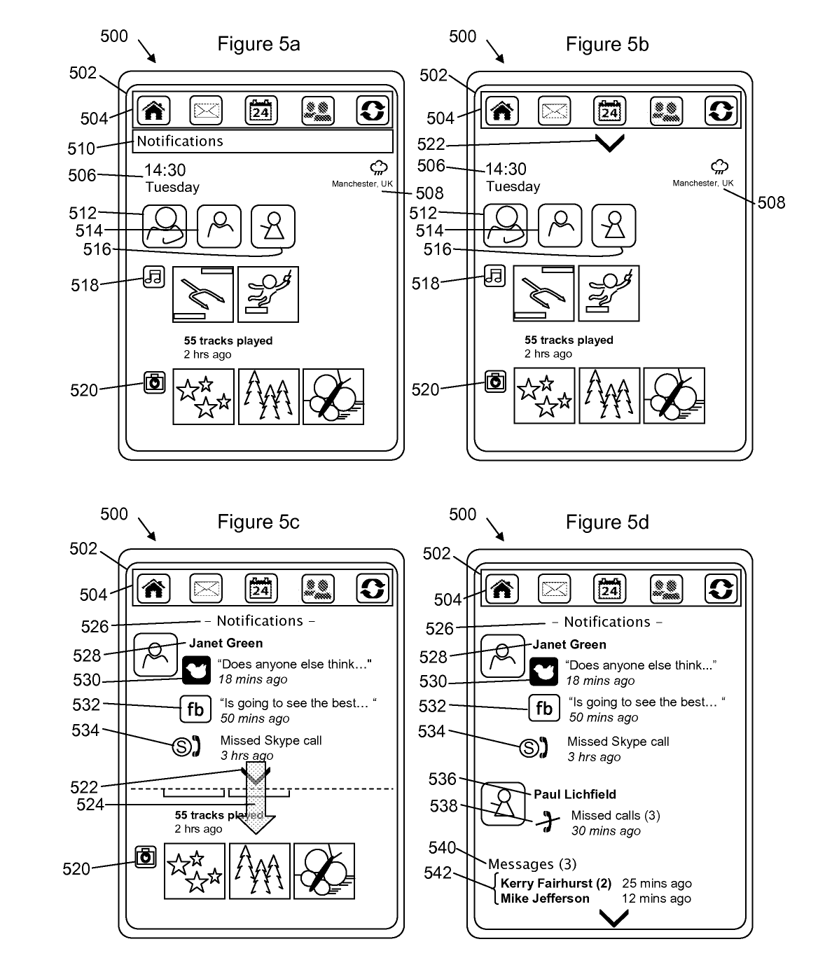

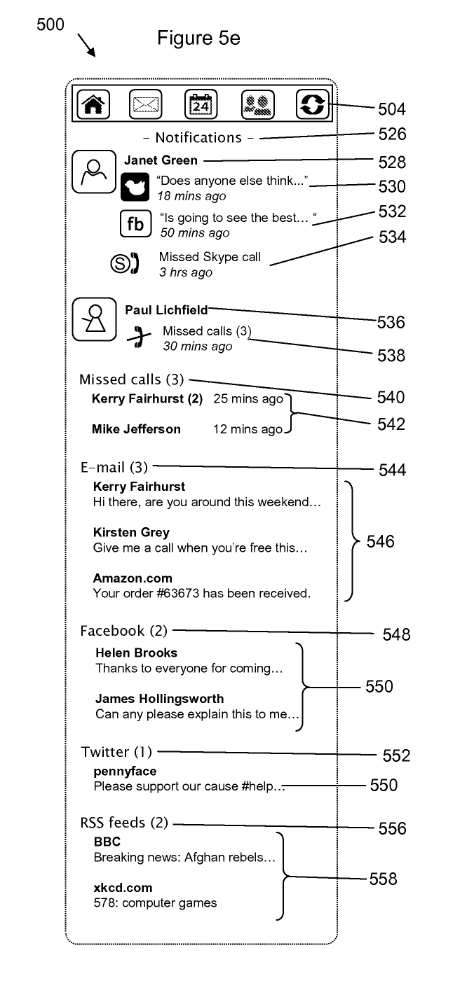

FIGS. 5a-5e illustrate an example embodiment of the apparatus which is a portable electronic device/apparatus 500, such as a smartphone, PDA, or tablet PC in use. The device 500 in this example is capable of running a plurality of user applications and storing the details of a plurality of contacts. Of course, the contact details could be stored on a cloud server, rather than on the device 500.

FIG. 5a shows the device 500 with an icon bar 502 displayed allowing the user to perform various operations such as navigating to the home page, accessing an e-mail application, accessing a calendar application, accessing a contacts list, or refreshing the screen/device. A notification bar 510 is also shown (labelled “Notifications”). As in the example of FIG. 4a, other background information may be displayed on the screen such as the day and date 506, or the location and current weather conditions 508.

The device 500 has a plurality of user applications available on the device similarly to FIG. 4a, including a music player 518, and a camera application 520. Other applications may be available but are not displayed in FIG. 5a. Also displayed in FIG. 5a are three icons 512, 514, 516 which indicate three particular contacts. These particular contacts and icons may have similar functionality to icons 412, 414 described in relation to FIGS. 4a-4c. The icons 512, 514, 516 are displaying indications of these particular contacts and may be considered to prioritise these contacts over other contacts, who do not have such an icon displayed.

FIG. 5b shows a different view of FIG. 5a, where the notification bar 510 is replaced by an indicator 522 such as an arrow. Such an indicator may be used to show the user that by, for example, dragging down on the arrow with a finger, a drop down screen/menu is accessible. Each alternative shown in FIGS. 5a and 5b for a notification bar 510 or notification screen indicator 522 may be considered to have its own advantages. A user may prefer to have a notification bar 510 always displayed on screen and such a bar may itself display icons or symbols to show, for example, that a new notification has been received of a user application event. The number of user application events and/or an indication of the related applications may be indicated on the bar (by, for example, displaying an icon associated with a particular application with a figure next to it in brackets to show how many notification events associated with that particular application are available). The embodiment of FIG. 5b may be considered to provide the advantage that more of the screen space is available (i.e. not taken up by a bar on the screen), which may be desirable if the user is, for example, reading text or playing a game on the device and a larger screen area provides a better experience.

FIG. 5c follows from the example of FIG. 5b and shows a notification bar indicator 522 rather than a notification bar 510. It will be appreciated that in FIG. 5c-5d, a notification bar could equally well be used rather than the notification bar indicator 522 shown. In FIG. 5c, a user is in the process of dragging 524 the notification bar indicator 522 down the screen to reveal the notification screen/menu. It can be seen that the music 518 and camera 520 applications are still available in the background. Therefore the notification of the collated user application events is available alongside a plurality of other user applications.

FIG. 5d shows that the user has dragged the notification bar indicator 522 down the screen fully to show the notification screen displayed over the majority of the screen area. The notification screen shows a title 526 and user application event notifications associated with one or more contacts. In FIG. 5d, four contacts are included as having transmitted user application events, indicated by their names 528, 536 and 542.

The contacts Janet Green 528 and Paul Lichfield 536 have been designated as particular (that is, favourite) contacts in this example. Thus any user application events related to them are collated and displayed associated with them. In FIG. 5d, the event notifications 530, 532, 534, and 538, associated with each particular contact are displayed next to their names 528, 536, Also in this example, an image/icon is displayed corresponding to each particular contact similar to those icons displayed 514, 516 in FIG. 5b. The collated user application events for these particular contacts 530, 532, 534, 538 are prioritised (shown first/at the top of the notification screen) over user application events from other contacts (such as Kerry Fairhurst and Mike Jefferson from whom the user has received missed call notifications 542).

Notifications of other user application events are displayed in FIG. 5d which are not from particular contacts, but are from other contacts. Notifications of messages 540 such as SMS and MMS messages are displayed 542. It will be appreciated that such grouping/collation is not by contact but by applications used. Also, more generally, it will be appreciated that there are various ways in which the notifications and contact details may be displayed in such a notification screen, including displaying (or not displaying): the contact name; an associated icon; the application name; a symbol corresponding to the application; the time passed since the notification was received; a time/day/date when the notification was received; the number of notifications for a given application or in total; and other information.

In the examples shown in FIGS. 5c-5e, the particular contact 528 has communicated user application events related to a plurality of user applications available on the electronic device. It may be that the user has different user names for their Twitter account, Facebook account, and Skype account. The particular contact may have an associated unique identifier, so that all the user application events relating to the same particular contact (related to the user application events 530, 532, 534) are displayed in a collated way as shown in FIGS. 5c-5e. In this way the user application events from a plurality of user applications, in which the same contact may have different user names, are collated for the same particular contact.

It may be the case that the user is required to scroll through the list of application user event notifications in the notification screen in order to access all the notifications. FIG. 5e shows an example of all the notifications which may be accessible in this example if the user were to scroll through the list of notifications.

FIG. 5e is a view of all notifications available, which may be displayed on the device and accessed by the user if, for example, the user were to scroll through the list of notifications. FIG. 5e illustrates that several user application events associated with several user applications may be included in a notification screen. Alongside the notifications collated 530, 532, 534, 538 for the particular users 528, 536, notifications for other applications are displayed, namely missed calls 540, e-mails 544, Facebook updates 548, Twitter posts 552, and RSS feeds 556. Therefore the user applications may be considered to be calling applications, text-based messaging applications, e-mail applications, social media applications, and news-feed applications. It will be appreciated that chat-based applications may also be included.

The user may be able to address one or more contacts listed in such a notification screen by, for example, selecting a contact or user application event on screen. For some user application events, one or more contacts may not be addressable. This is the case with the RSS feeds 556 displayed at the end of the notification screen in FIG. 5e. An RSS feed is a type of news feed and may be considered as a one-way communication, where the user has subscribed to receive user application events (updates) via an RSS feed, but the user cannot reply to such a feed. In FIG. 5e, the user has received notifications of RSS feeds from the ‘contacts’ the BBC and the web comic xkcd.com, neither of which the user is able to address.

In FIGS. 5c-5e it can be seen that at least a portion of the collated user applications events can be seen. In FIG. 5c, at least a portion of the collated user applications events can be seen alongside icons representing a plurality of user applications. The examples shown in FIGS. 5a-5e may be considered to allow a user more efficient access to information for contacts of particular interest, as the details the user application activity/events in different applications for such contacts are available in collated form in a notification bar which may be present regardless of the application currently being used on the device.

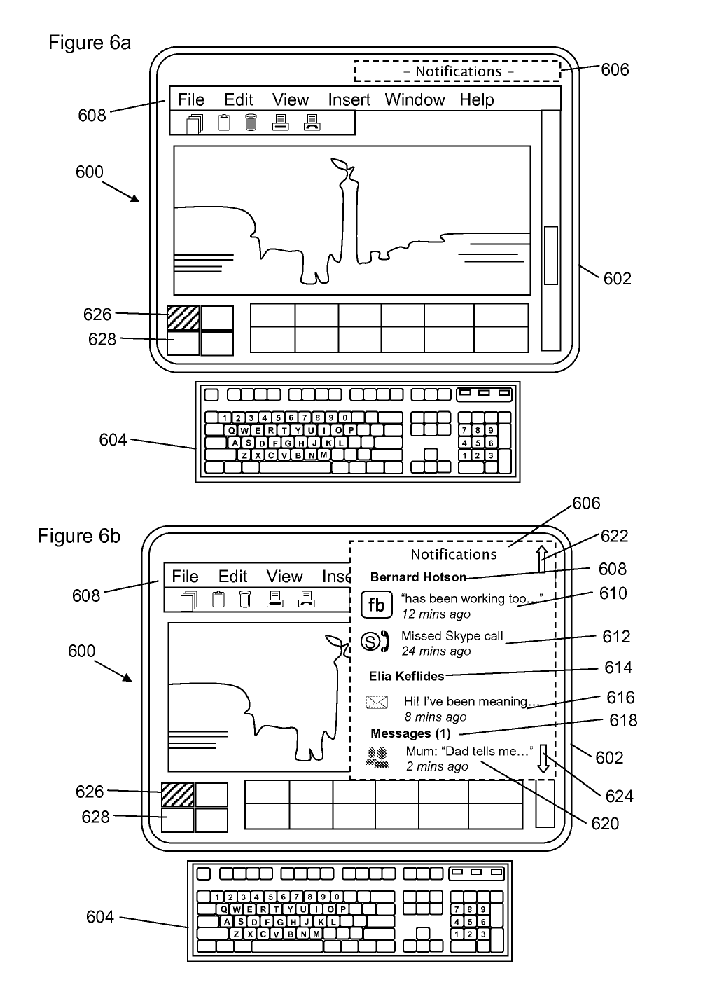

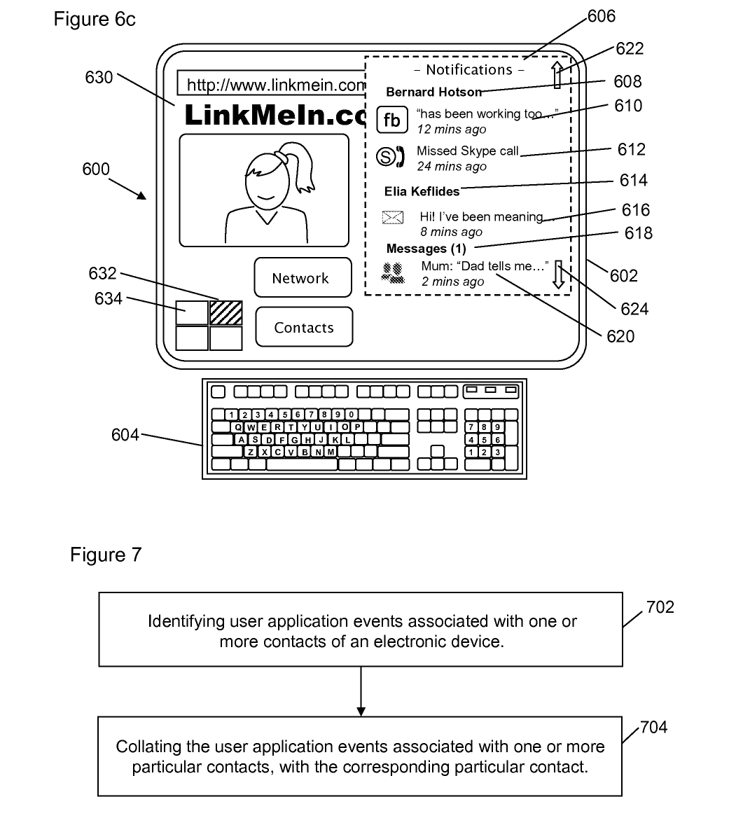

FIGS. 6a-6c illustrate an example embodiment of the apparatus which is an electronic device 600, such as a laptop computer or desktop computer in use. The device may be portable or non-portable. The device 600 in this example comprises a monitor 602 and physical keyboard 604. Other peripheral devices may form part of the device 600 such as a mouse, speakers, a webcam, microphone, or other device. The device is capable of running a plurality of applications and may be used for communication with contacts, or for stand-alone tasks which do not require communication with other contacts.

FIG. 6a shows the device/apparatus 600 with a notification bar 606 displayed in the top right of the screen. An application is running on the device/apparatus, which in FIGS. 6a (and 6b) may be photo or design application. Other background information may be displayed on the screen and/or a plurality of other user applications may be running and/or available on the device.

FIG. 6b shows that the notification bar 606 has been opened to reveal a notification screen. The notification screen may have been opened by a user, for example, clicking on the notification bar 606 with a mouse pointer, or it may have opened automatically by the apparatus, for example as a new notification is received. The notification screen may be part of a pop-up, blow out, drop-down menu, a banner, an events screen, and may be text and/or icon based. The notification screen shows user application event notifications associated with one or more contacts. Two particular contacts, Bernard Hotson 608 and Elia Keflides 614, are shown with associated user application events 610, 612, 616 as shown in the notification screen. Other user application events have also been detected and are displayed in the notification screen, including chat messages 618, 620 received.

The collated user application events 610, 612, 616 associated with one or more particular contacts 608, 614, are prioritised over user application events from one or more other contacts, e.g. 620. They are prioritised in that they are displayed at the top of the notification screen and so they are seen first by the user upon the notification screen being opened. The user may be able to scroll through the notification screen using a scroll bar or arrows 622, 624, to view all received notifications. The user may be required to scroll down the list in order to view user application event notifications from contacts that are not particular contacts.

The particular contacts 608, 614, and other contacts may be addressable by the apparatus. The user may be able to select a contact 608, 614 and subsequently contact them using the apparatus, or the user may be able to select a user application event notification 610, 612, 616, 620, and respond to it by, for example, clicking on it. For example, a user may be able to click on the missed Skype call 612 and open/activate the Skype application, and also possibly initiate a call with the contact 608. Alternatively the user may be able to select the e-mail notification 616 which may open the received e-mail from contact 614 and allow the user to reply. Alternatively, the user may be able to click on a contact name, e.g. 614, and have the option of contacting that person via any available application such as a chat application, an internet calling application, via e-mail, or post a message on that contact's social media space.

At least a portion of the collated user application events are displayed on screen, such as the initial part of a Facebook status update 610 or the initial part of a received e-mail 616. In this case such portions of collated user application events are available alongside a plurality of user applications. It may be imagined that the notification bar 606 is available regardless of which application, or the number of applications, running on the apparatus. For example, the apparatus may allow the user to use several ‘desktops’ at any one time. FIGS. 6a and 6b shows the user using a photo/design application on one desktop 626, but other desktops 628 are available for, e.g. using other applications. In FIG. 6c, the user is browsing a professional social media website on a different desktop 632 and is not currently using the previous desktop 634 on which the photo/design application is running. However, the apparatus is able to provide the user with the notification bar 606 alongside any number of applications whether running on the same desktop or over several desktops. In this way the user may experience a seamless availability of the collated notifications relating to collated user application events from particular contacts, and for other contacts, in a plurality of user applications. The user may also have the option of hiding or minimising the notification bar, or moving it to the bottom or side of the screen.

In the examples shown in FIGS. 6b and 6c, the particular contact indicated by name 608 has communicated user application events related to a plurality of user applications available on the electronic device. It may be that the user has a different Facebook ID (such as “Bernie Hotson”) and Skype ID (such as “Bernard_HBW_UK”). The particular contact 608 may have an associated unique identifier, which may be assigned to the contacts Facebook ID and Skype ID (and any other user names/online IDs used by that particular contact) so that all the user application events 610, 612 related to this contact person 608 are displayed in a collated way. In this way the user application events from a plurality of user applications, in which the same contact may have different user names, are collated for the same particular contact. Again, the user may not wish to see user application events in the Notification screen for any news feeds, and so the user may select to omit news feed user application events from the notification screen. In another example, the user may not wish to see user application events in the notification screen for any news feeds from one particular contact website (e.g. from “the Onion” spoof news website) and so the user may select to omit news feed user application events from the notification screen received from “the Onion”.

In one or more of the embodiments described, it may be envisaged that if a user is not using the apparatus for a period of time, but is able to access user application events via a different device, that the apparatus does not include user application event notifications for events already seen by the user on the different device. For example, the apparatus may be a mobile phone which the user does not use for a period of time, but the user is using a desktop computer with which they can check their social media accounts and RSS feeds in that same period. In this case, any user application event received by the mobile phone but which has been seen by the user using the desktop computer may not appear in any list of user application events on the mobile phone. Thus the user application events available on the mobile phone may not include social media updates and RSS feeds. Other user application events received by the mobile phone which the user has not seen by using the desktop computer (or otherwise), such as missed calls and SMS messages, may still be available in a list of user application events on the mobile phone. In this way, the user receives synchronised user application event information and does not receive notifications twice or more for the same user application event because they are using more than one device to access user applications.

It may be the case that user notification events remain in a notification bar/menu available for the user until the user actively chooses to remove them from the bar/menu. It may be that the user application events are removed from the notification bar/menu after a user has interacted with the user application event, for example by selecting a notification of a received e-mail in order to read the e-mail in full, or by selecting a missed call in order to reply to the call. It may be that user application events are no longer shown in any notification bar/menu after a preset period of time. For example, any user application event received by the device over one week ago or a day ago may no longer be displayed. A general user application event indicator may be included in this case informing the user that user application event(s) older than one week, or a day, are available and the user is required to provide a further input, such as tapping this indicator, in order to see the older events.

It may be that the user has the possibility to select which user applications of all those available are to be included when considering which user application events to collate and make available for the user. For example, the user may follow several hundred contacts on Twitter, and may not wish to receive a user application event notification each time one of these contacts posts an entry. Therefore the user may have the option of excluding user application events from either contacts associated only with Twitter user application events, or excluding Twitter from the user applications included in any notification bar/menu. It may be that, even if the user does not allow Twitter user application events to be shown in any notification bar/menu, an exception is made for particular contacts for whom Twitter user application events are still included and collated for the particular contacts. Some applications which are associated with events could be excluded from the collation process, based on the user changing the device setting to exclude particular applications, or by the apparatus determining, from user activity relating to the collated notifications, which are of least interest to the user.

FIG. 7 shows a flow diagram illustrating the steps of identifying, from a plurality of user applications available on an electronic device, user application events associated with one or more contacts addressable using the electronic device 702 and collating the user application events, from the plurality of user applications available associated with one or more particular contacts, with the corresponding particular contact 704, and is self-explanatory.

FIG. 8 illustrates schematically a computer/processor readable medium 800 providing a program according to an embodiment. In this example, the computer/processor readable medium is a disc such as a digital versatile disc (DVD) or a compact disc (CD). In other embodiments, the computer readable medium may be any medium that has been programmed in such a way as to carry out an inventive function. The computer program code may be distributed between the multiple memories of the same type, or multiple memories of a different type, such as ROM, RAM, flash, hard disk, solid state, etc.

User inputs may be gestures which comprise one or more of a tap, a swipe, a slide, a press, a hold, a rotate gesture, a static hover gesture proximal to the user interface of the device, a moving hover gesture proximal to the device, bending at least part of the device, squeezing at least part of the device, a multi-finger gesture, tilting the device, or flipping the device.

The apparatus shown in the above embodiments may be a portable electronic device, a laptop computer, a mobile phone, a Smartphone, a tablet computer, a personal digital assistant, a digital camera, a watch, a non-portable electronic device, a desktop computer, a monitor, a server, or a module/circuitry for one or more of the same.

Any mentioned apparatus/device and/or other features of particular mentioned apparatus/device may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

Any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

Any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

The term “signalling” may refer to one or more signals transmitted as a series of transmitted and/or received electrical/optical signals. The series of signals may comprise one, two, three, four or even more individual signal components or distinct signals to make up said signalling. Some or all of these individual signals may be transmitted/received by wireless or wired communication simultaneously, in sequence, and/or such that they temporally overlap one another.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features as applied to preferred embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
at least one processor; and
at least one memory including computer program code,
the at least one memory and the computer program code configured to, with the at least one processor, cause the apparatus to perform at least the following:
identify, for a plurality of contacts of an electronic device, respective user application events, the user application events being in respect of a particular contact;
collate the respective user application events, from user application events associated with a plurality of user applications available on the electronic device, with the corresponding particular contact of the plurality of contacts; and
display in a notification screen, for a plurality of contacts, at least a portion of the respective collated user application events associated with the corresponding particular contact.

2. (canceled)

3. (canceled)

4. The apparatus of claim 1, wherein the one or more contacts are addressable using at least one of the plurality of user applications.

5. The apparatus of claim 4, wherein the one or more contacts addressable using at least one of the plurality of user applications each have an associated unique identifier.

6. The apparatus of claim 1, wherein the one or more contacts are not addressable using at least one of the plurality of user applications.

7. The apparatus of claim 1, wherein the user can select which, of the plurality of user application events, are collated for a particular contact.

8. The apparatus of claim 1, wherein the collated user application events associated with one or more particular contacts, of the plurality of contacts, are prioritized over collated user application events from one or more other contacts.

9. (canceled)

10. (canceled)

11. (canceled)

12. (canceled)

13. The apparatus of claim 1, wherein the collated user application events are displayed using a combination of one or more of: a text-based list, a list of icons, a drop-down menu, a notification bar, a pop-up notification, a banner, a notification menu, a blow-out, and an events screen.

14. The apparatus of claim 1, wherein the user application is one of a calling application, a text-based messaging application, an e-mail application, a social media application, a news feed application, or a chat application.

15. The apparatus of claim 1, wherein the apparatus is a portable electronic device, a laptop computer, a mobile phone, a Smartphone, a tablet computer, a personal digital assistant, a digital camera, a watch, a server, or a module/circuitry for one or more of the same.

16. The apparatus of claim 1, wherein the apparatus is a non-portable electronic device, a desktop computer, a monitor, a server, or a module/circuitry for one or more of the same.

17. A method, the method comprising:
identifying, for a plurality of contacts of an electronic device, respective user application events, the user application events being in respect of a particular contact;
collating the respective user application events, from user application events associated with a plurality of user applications available on the electronic device, with the corresponding particular contact of the plurality of contacts; and
display in a notification screen, for a plurality of contacts, at least a portion of the respective collated user application events associated with the corresponding particular contact.

18. A computer readable medium comprising computer program code stored thereon, the computer readable medium and computer program code being configured to, when run on at least one processor, perform at least the following:
identify, for a plurality of contacts of an electronic device, respective user application events, the user application events being in respect of a particular contact;
collate the respective user application events, from user application events associated with a plurality of user applications available on the electronic device, with the corresponding particular contact of the plurality of contacts; and
display in a notification screen, for a plurality of contacts, at least a portion of the respective collated user application events associated with the corresponding particular contact.

19. The apparatus of claim 1, wherein the apparatus is configured such that scrolling through the notification screen is required to view all the collated user application events for the plurality of contacts.
